(19) United States
(12) Patent Application Publication
(10) Pub. No.: US 2013/0221880 A1
(43) Pub. Date: Aug. 29, 2013

(54) MOTOR DRIVING CIRCUIT AND MOTOR APPARATUS

(71) Applicant: Toshikazu SEKIHARA, Kawasaki-shi (JP)

(72) Inventor: Toshikazu SEKIHARA, Kawasaki-shi (JP)

(73) Assignee: Kabushiki Kaisha Toshiba, Tokyo (JP)

(21) Appl. No.: 13/556,563

(22) Filed: Jul. 24, 2012

(30) Foreign Application Priority Data
Feb. 29, 2012 (JP) 2012-043798

(51) Int. Cl. H02P 6/18

(52) U.S. Cl. 318/400.09

(57) ABSTRACT

The motor driving circuit includes a driving controlling signal generating circuit that controls a driver with a driving controlling signal. The motor driving circuit includes a detecting circuit that outputs a first voltage signal based on a driving current flowing to the driver in a case where the motor is being driven by direct-current excitation driving. The motor driving circuit includes a calculating circuit that removes a direct-current component from the first voltage signal and outputs a resulting second voltage signal. The motor driving circuit includes a determining circuit that determines, based on an amplitude of the second voltage signal, whether or not to make the motor transition from the direct-current excitation driving to forced commutation driving and outputs a determination signal according to a result of the determination to the driving controlling signal generating circuit.

### CROSS-REFERENCE TO RELATED APPLICATION

This application is based upon and claims the benefit of priority from the prior Japanese Patent Application No. 2012-043798, filed on Feb. 29, 2012, the entire contents of which are incorporated herein by reference.

### BACKGROUND

1. Field

Embodiments described herein relate generally to a motor driving circuit and a motor apparatus.

2. Background Art

A conventional motor driving circuit conducts position sensorless driving of a brushless DC motor used in a fan or the like.

The conventional motor driving circuit positions a rotor on a time basis, for example.

However, this scheme does not take the state of the rotor into consideration in starting direct-current excitation driving and transitioning to the following forced commutation driving after the lapse of a predetermined time.

Therefore, if the forced commutation driving starts when the rotor is rotating or vibrating because of wind or other external disturbance, the rotor is not in the proper state, and therefore it is difficult to activate the motor.

### BRIEF DESCRIPTION OF THE DRAWINGS

FIG. 1 is a diagram showing an example of a configuration of a motor apparatus 1000 according to a first embodiment.

FIG. 2 is a circuit diagram showing an example of a configuration of the driver “D” and the resistor circuit “R” shown in FIG. 1;

FIG. 3 is a waveform diagram showing an example of the waveform of a driving current flowing through the driver “D” shown in FIG. 1 during activation;

FIG. 4 is a waveform diagram showing an example of the waveform of the voltage “VmU” detected by the detecting circuit 4 shown in FIG. 1 during activation;

FIG. 5 is a waveform diagram showing an example of the waveform of the first voltage signal “S1” output from the detecting circuit 4 shown in FIG. 1 during activation;

FIG. 6 is a waveform diagram showing an example of the waveform of the second voltage signal “S2” output from the calculating circuit 3 shown in FIG. 1 during activation; and

FIG. 7 is a waveform diagram showing an example of the waveform of the second voltage signal “S2” along with the threshold “Vth”.

### DETAILED DESCRIPTION

A motor driving circuit according to an embodiment performs sensorless driving of a motor. The motor driving circuit includes a driving controlling signal generating circuit that controls a driver with a driving controlling signal, the driver supplying a driving voltage to the motor, and the driving voltage driving the motor. The motor driving circuit includes a detecting circuit that outputs a first voltage signal based on a driving current flowing to the driver in a case where the motor is being driven by direct-current excitation driving. The motor driving circuit includes a calculating circuit that removes a direct-current component from the first voltage signal and outputs a resulting second voltage signal. The motor driving circuit includes a determining circuit that determines, based on an amplitude of the second voltage signal, whether or not to make the motor transition from the direct-current excitation driving to forced commutation driving and outputs a determination signal according to a result of the determination to the driving controlling signal generating circuit.

In the following, an embodiment will be described with reference to the drawings. In the following embodiment, a case will be described where the present invention is applied to control of a three-phase motor whose rotational speed is controlled by a three-phase driving voltage. However, the present invention can be equally applied to other types of motors whose rotational speed is controlled by a driving voltage.

### First Embodiment

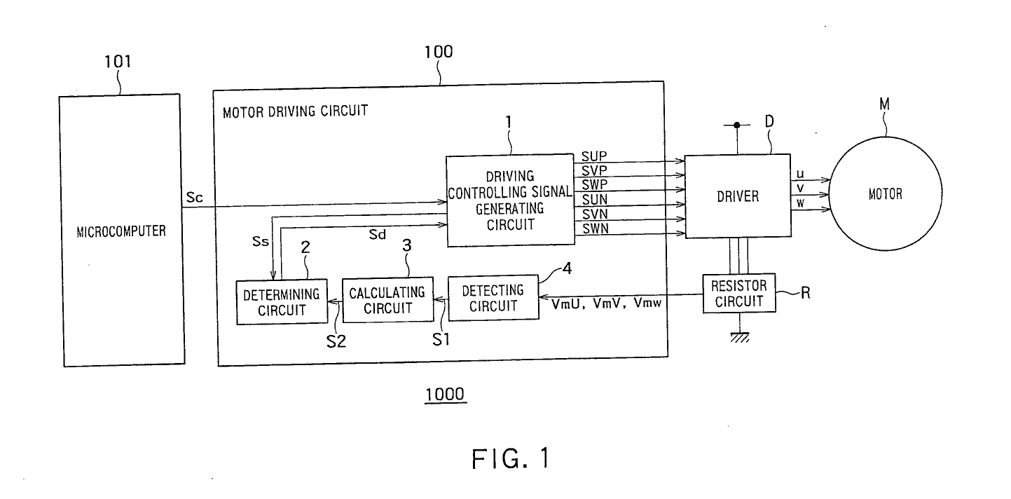

FIG. 1 is a diagram showing an example of a configuration of a motor apparatus 1000 according to a first embodiment.

As shown in FIG. 1, the motor apparatus 1000 includes a motor driving circuit 100, a driver “D”, a motor “M” and a resistor circuit “R”. Although FIG. 1 shows the motor driving circuit 100 and the driver “D” as separate components, the motor driving circuit 100 and the driver “D” can be integrated. Alternatively, the motor driving circuit 100, the driver “D” and the resistor circuit “R” may be integrated.

The motor apparatus 1000 is used for driving a fan or a compressor in a product such as an air conditioner and a refrigerator, for example. The motor driving circuit 100 is controlled by a microcomputer 101.

The microcomputer 101 is configured to output a command signal “Sc” that prescribes driving of the motor “M” to the motor driving circuit 100. The microcomputer 101 is further configured to perform a predetermined control on the product described above such as an air conditioner and a refrigerator.

In this embodiment, the motor “M” is a three-phase motor (more specifically, a three-phase brushless DC motor). As described above, the motor “M” may be other types of motors whose rotational speed is controlled by the driving voltage.

The driver “D” is connected to a power supply at one end thereof and grounded through the resistor circuit “R” at the other end. The driver “D” is configured to receive a power supply voltage supplied from the power supply. The driver “D” generates a three-phase driving voltage for driving the motor “M” from the power supply voltage. The driver “D” is configured to supply the power supply voltage as three phases of driving voltage “U”, “V” and “W” to the motor “M” in response to driving controlling signals “SUP”, “SVP”, “SWP”, “SUN”, “SVN” and “SWN”.

The resistor circuit “R” is connected to the driver “D”.

The motor driving circuit 100 is configured to perform sensorless driving of the motor “M” in response to the command signal “Sc”.

Specifically, the motor driving circuit 100 first makes the driver “D” perform direct-current excitation driving of the motor “M” to rotate the rotor to a predetermined position in response to the command signal “Sc”. Then, the motor driving circuit 100 makes the driver “D” perform forced commutation driving of the motor “M” to forcedly rotate the motor “M” until the rotational speed reaches a predetermined rotational speed. Then, when the rotational speed of the motor “M” is higher than the predetermined rotational speed, the motor driving circuit 100 starts sensorless driving of the motor “M” according to a driving current flowing to the driver “D”.

As shown in FIG. 1, the motor driving circuit 100 has a driving controlling signal generating circuit 1, a determining circuit 2, a calculating circuit 3, and a detecting circuit 4, for example.

The driving controlling signal generating circuit 1 is configured to output the driving controlling signal to control the driver “D” that supplies the driving voltage for driving the motor “M” to the motor “M” according to the command signal “Sc” output from the microcomputer 101.

The driving controlling signal generating circuit 1 is configured to output the driving controlling signal to control the driver “D” so as to perform forced commutation driving of the motor “M” if a determination signal “Sd” indicates that it is determined to transition to the forced commutation driving.

The driving controlling signal generating circuit 1 is configured to output the driving controlling signal to control the driver “D” so as to perform direct-current excitation driving of the motor “M” and output a direct-current excitation starting signal “Ss” to the determining circuit 2 if the command signal “Sc” indicates to perform direct-current excitation driving of the motor “M”.

The detecting circuit 4 is configured to output a first voltage signal “S1” based on the driving current flowing to the driver “D” if the motor “M” is driven by direct-current excitation driving.

For example, the detecting circuit 4 detects a voltage value responsive to a voltage drop caused by the driving current flowing from the driver “D” to the resistor circuit “R”, and outputs the first voltage signal “S1” according to the detection result.

The calculating circuit 3 is configured to remove a direct-current component from the first voltage signal “S1” and output the resulting signal, which is a second voltage signal “S2”.

The determining circuit 2 is configured to determine based on the amplitude of the second voltage signal “S2” whether or not to transition from the direct-current excitation driving of the motor “M” to the forced commutation driving and output the determination signal “Sd” according to the determination result to the driving controlling signal generating circuit 1.

That is, the determining circuit 2 is configured to compare the amplitude of the second voltage signal “52” with a threshold “Vth” and determine to transition from the direct-current excitation driving of the motor “M” to the forced commutation driving if the amplitude is lower than the threshold “Vth” for a preset reference period “x”.

For example, the determining circuit 2 starts comparison between the amplitude of the second voltage signal “S2” and the threshold “Vth” in response to the direct-current excitation starting signal “Ss” output from the driving controlling signal generating circuit 1 to start direct-current excitation driving. Then, when the amplitude of the second voltage signal “S2” is lower than the threshold “Vth” for the reference period “x”, the determining circuit 2 outputs the determination signal “Sd” that indicates that it is determined to transition the forced commutation driving.

As described above, if the determination signal “Sd” indicates that it is determined to transition to the forced commutation driving, the driving controlling signal generating circuit 1 outputs the driving controlling signal to control the driver “D” so as to perform forced commutation driving of the motor “M”.

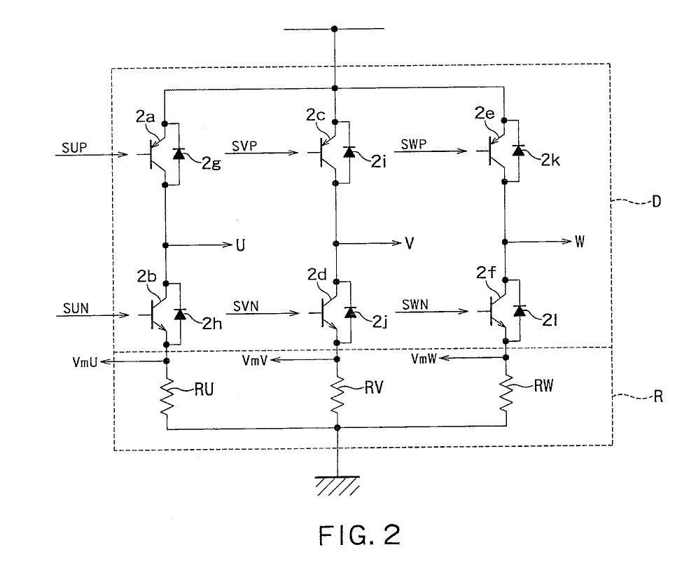

FIG. 2 is a circuit diagram showing an example of a configuration of the driver “D” and the resistor circuit “R” shown in FIG. 1. Although the driver “D” is composed of bipolar transistors in the example shown in FIG. 2, the driver “D” may be composed of MOS transistors.

As shown in FIG. 2, the driver “D” includes a first transistor (PNP type bipolar transistor) “2a”, a second transistor (NPN type bipolar transistor) “2b”, a third transistor (PNP type bipolar transistor) “2c”, a fourth transistor (NPN type bipolar transistor) “2d”, a fifth transistor (PNP type bipolar transistor) “2e”, a sixth transistor (NPN type bipolar transistor) “2f”, and six diodes “2g” to “2l”, for example. Although the example in FIG. 2 shows a case of low voltage, the driver “D” can be composed of a pre-driver circuit (not shown) and six NPN type transistors in the case of high voltage.

The first transistor “2a” is connected to the power supply at one end (emitter) thereof and is configured to receive a first driving controlling signal “SUP” output from the driving controlling signal generating circuit 1 at a control terminal (base) thereof.

The diode “2g” is connected to the emitter and the collector of the first transistor “2a” at the cathode and the anode thereof, respectively.

The second transistor “2b” is connected to the other end (collector) of the first transistor “2a” at one end (collector) thereof and is configured to receive a second driving controlling signal “SUN” output from the driving controlling signal generating circuit 1 at a control terminal (base) thereof.

The diode “2h” is connected to the collector and the emitter of the second transistor “2b” at the cathode and the anode thereof, respectively.

A first terminal “T1” between the first transistor “2a” and the second transistor “2b” is connected to a coil of a first phase (U phase) of the motor “M”. A first driving voltage “U” is output at the first terminal “T1”.

The third transistor “2c” is connected to the power supply at one end (emitter) thereof and is configured to receive a third driving controlling signal “SVP” output from the driving controlling signal generating circuit 1 at a control terminal (base) thereof.

The diode “2i” is connected to the emitter and the collector of the third transistor “2c” at the cathode and the anode thereof, respectively.

The fourth transistor “2d” is connected to the other end (collector) of the third transistor “2c” at one end (collector) thereof and is configured to receive a fourth driving controlling signal “SVN” output from the driving controlling signal generating circuit 1 at a control terminal (base) thereof.

The diode “2j” is connected to the collector and the emitter of the fourth transistor “2d” at the cathode and the anode thereof, respectively.

A second terminal “T2” between the third transistor “2c” and the fourth transistor “2d” is connected to a coil of a second phase (V phase) of the motor “M”. A second driving voltage “V” is output at the second terminal “T2”.

The fifth transistor “2e” is connected to the power supply at one end (emitter) thereof and is configured to receive a fifth driving controlling signal “SWP” output from the driving controlling signal generating circuit 1 at a control terminal (base) thereof.

The diode “2k” is connected to the emitter and the collector of the fifth transistor “2e” at the cathode and the anode thereof, respectively.

The sixth transistor “2f” is connected to the other end (collector) of the fifth transistor “2e” at one end (collector) thereof and is configured to receive a sixth driving controlling signal “SWN” output from the driving controlling signal generating circuit 1 at a control terminal (base) thereof.

The diode “21” is connected to the collector and the emitter of the sixth transistor “2f” at the cathode and the anode thereof, respectively.

A third terminal “T3” between the fifth transistor “2e” and the sixth transistor “2f” is connected to a coil of a third phase (W phase) of the motor “M”. A third driving voltage “W” is output at the third terminal “T3”.

The motor “M” is configured to be driven by currents flowing through the coils of the three phases thereof caused by the driving voltages “U”, “V” and “W” of the three phases described above.

As shown in FIG. 2, the resistor circuit “R” has a first resistor “RU”, a second resistor “RV” and a third resistor “RW”, for example.

The first resistor “RU” is connected between the other end (emitter) of the second transistor “2b” and the ground.

The second resistor “RV” is connected between the other end (emitter) of the fourth transistor “2d” and the ground.

The third resistor “RW” is connected between the other end (emitter) of the sixth transistor “2f” and the ground.

The resistors “RU”, “RV” and “RW” are connected between the second transistor “2b” and the ground, between the fourth transistor “2d” and the ground, and between the sixth transistor “2f” and the ground, respectively. That is, the same currents as those flowing through the coils of the motor “M” flow through the resistors “RU”, “RV” and “RW”. Therefore, signals “VmU”, “VmV” and “VmW”, which are currents through or voltages on the resistors “RU”, “RV” and “RW”, are proportional to the currents flowing through the motor “M” (the coils of the motor “M”).

For example, the detecting circuit 4 shown in FIG. 1 detects the voltage “VmU” between the other end (emitter) of the second transistor “2b” and the first resistor “RU” and outputs the first voltage signal “Si” according to the detection result.

Alternatively, the detecting circuit 4 may detect the voltage “VmV” or “VmW” and output the first voltage signal “S1” according to the detection result.

Next, an example of an operation of the motor driving circuit 100 configured as described above will be described.

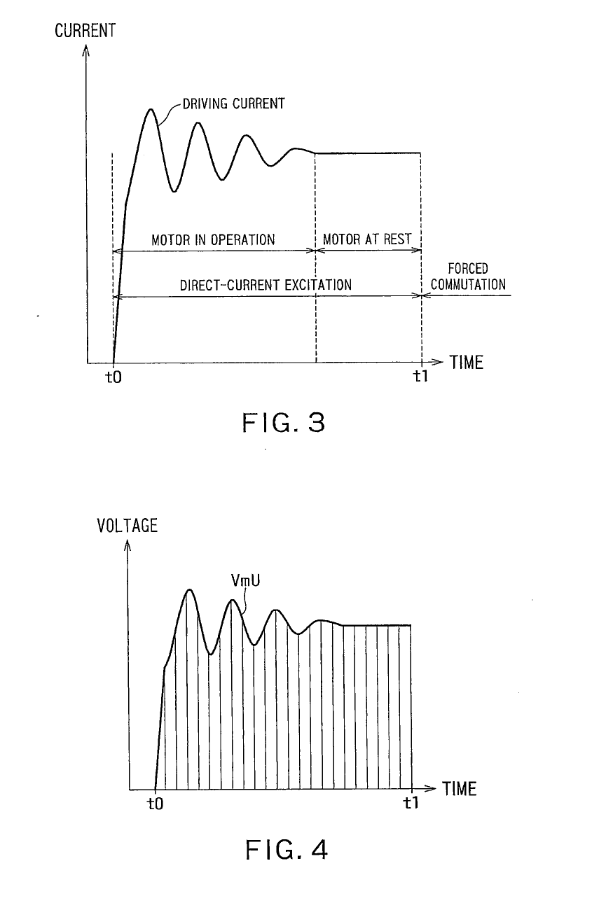

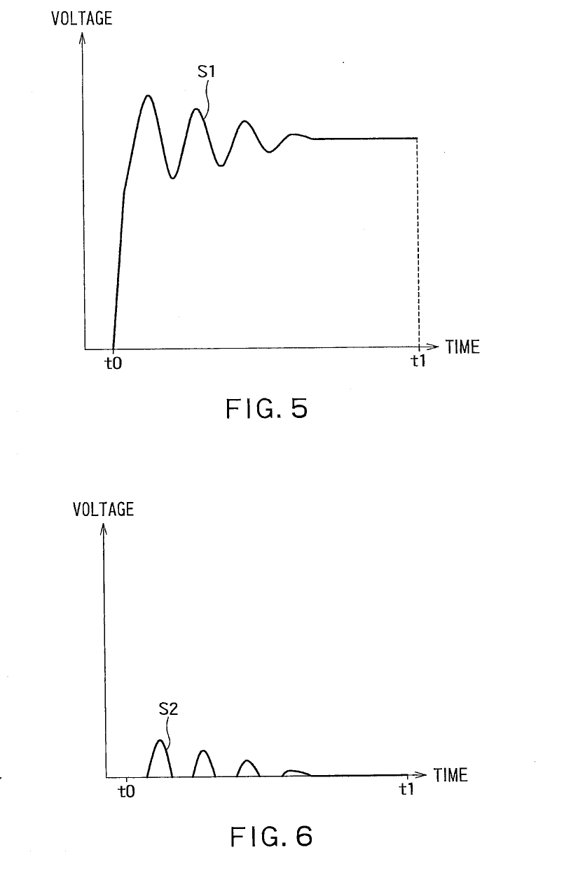

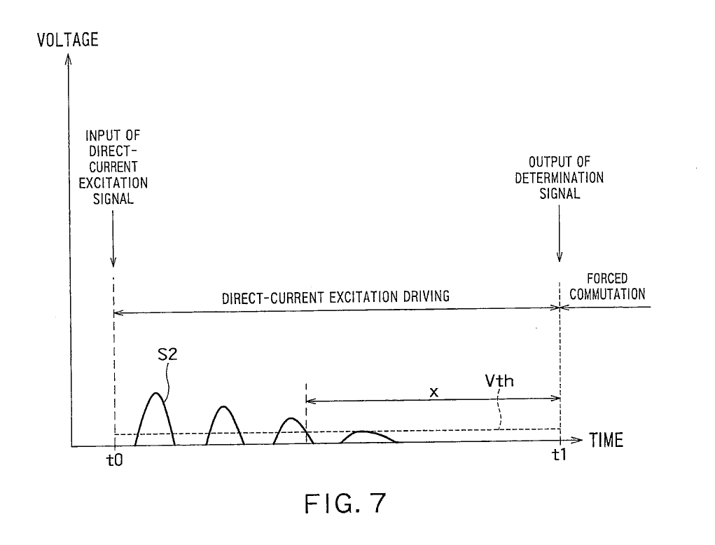

FIG. 3 is a waveform diagram showing an example of the waveform of a driving current flowing through the driver “D” shown in FIG. 1 during activation. FIG. 4 is a waveform diagram showing an example of the waveform of the voltage “VmU” detected by the detecting circuit 4 shown in FIG. 1 during activation. FIG. 5 is a waveform diagram showing an example of the waveform of the first voltage signal “S1” output from the detecting circuit 4 shown in FIG. during activation. FIG. 6 is a waveform diagram showing an example of the waveform of the second voltage signal “S2” output from the calculating circuit 3 shown in FIG. 1 during activation. FIG. 7 is a waveform diagram showing an example of the waveform of the second voltage signal “S2” along with the threshold “Vth”.

For example, during activation, if the rotor is not originally positioned at a predetermined position and thus is repositioned to the predetermined position (by direct-current excitation), the movement of the rotor induces a voltage.

As a result, as shown in FIG. 3, the driving current fluctuates in a period from a time “t0” to a time “t1” in which the direct-current excitation driving occurs. The fluctuation converges with time, and the motor enters into a motor stop state (since the time “t1”). The same holds true for a case where the motor is originally rotating by the action of wind or the like.

As shown in FIG. 4, during the positioning, the voltage “VmU” is low and has a waveform of the driving current subject to PWM. The detecting circuit 4 detects the voltage “VmU” responsive to the voltage drop caused by the driving current flowing from the driver “D” to the resistor circuit “R” and outputs the first voltage signal “S1” according to the detection result (FIG. 5)

As described above, the calculating circuit 3 removes the direct-current component from the first voltage signal “S1” and outputs the resulting second voltage signal “S2” (FIG. 6). The direct-current component varies as the driving current varies in response to the command signal. In other words, the influence of the variation of the driving current can be reduced with the command signal. This facilitates the determination in the following step.

The determining circuit 2 starts comparison between the amplitude of the second voltage signal “52” and the threshold “Vth” in response to the direct-current excitation starting signal “Ss” as shown in FIG. 7 (time “t0”). Then, the determining circuit 2 outputs the determination signal “Sd” that indicates that it is determined to transition to the forced commutation driving when the amplitude of the second voltage signal “S2” is lower than the threshold “Vth” for the reference period “x” (time “t1”).

In response to the direct-current excitation completion signal, the driving controlling signal generating circuit 1 transitions to the forced commutation driving, which is the next driving sequence.

In the positioning, if the fluctuation does not converge because of wind or other external disturbance, the determining circuit 2 does not output the determination signal “Sd”. Accordingly, the transition to the next driving sequence does not occur, and the period continues in which no signal responsive to the rotational speed of the motor “M” is output. For example, in response to the signal not being output, a retry can be performed after the lapse of a predetermined time or by reissuing the command signal.

The detecting circuit 4 may have a CR filter and detect the driving current by sample holding according to an energization signal.

As described above, in position sensorless driving of the three-phase brushless DC motor, transition from the rotor positioning operation to the following forced commutation operation occurs after the rotor comes to rest, so that the motor can be activated with reliability.

In addition, there is no need to waste time in waiting for a predetermined time to pass if the rotor being positioned comes to rest within the predetermined time, so that the activation time can be reduced.

As described above, the motor apparatus 1000 according to the first embodiment can activate the motor with higher reliability.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motor driving circuit that performs sensorless driving of a motor, the motor driving circuit comprising:
a driving controlling signal generating circuit that controls a driver with a driving controlling signal, the driver supplying a driving voltage to the motor, and the driving voltage driving the motor;
a detecting circuit that outputs a first voltage signal based on a driving current flowing to the driver in a case where the motor is being driven by direct-current excitation driving;
a calculating circuit that removes a direct-current component from the first voltage signal and outputs a resulting second voltage signal; and
a determining circuit that determines, based on an amplitude of the second voltage signal, whether or not to make the motor transition from the direct-current excitation driving to forced commutation driving and outputs a determination signal according to a result of the determination to the driving controlling signal generating circuit.

2. The motor driving circuit according to claim 1, wherein the driving controlling signal generating circuit
controls the driver with the driving controlling signal to perform forced commutation driving of the motor in a case where the determination signal indicates that it is determined to transition to the forced commutation driving.

3. The motor driving circuit according to claim 1, wherein the determining circuit
compares the amplitude of the second voltage signal with a threshold and determines to transition from the direct-current excitation driving of the motor to the forced commutation driving in a case where the amplitude is lower than the threshold for a preset reference period.

4. The motor driving circuit according to claim 2, wherein the determining circuit
compares the amplitude of the second voltage signal with a threshold and determines to transition from the direct-current excitation driving of the motor to the forced commutation driving in a case where the amplitude is lower than the threshold for a preset reference period.

5. The motor driving circuit according to claim 3, wherein the determining circuit
starts the comparison between the amplitude of the second voltage signal and the threshold in response to a direct-current excitation start signal output from the driving controlling signal generating circuit to start the direct-current excitation driving, and
outputs the determination signal that indicates that it is determined to transition to the forced commutation driving in the case where the amplitude is lower than the threshold for the reference period.

6. The motor driving circuit according to claim 4, wherein the determining circuit
starts the comparison between the amplitude of the second voltage signal and the threshold in response to a direct-current excitation start signal output from the driving controlling signal generating circuit to start the direct-current excitation driving, and
outputs the determination signal that indicates that it is determined to transition to the forced commutation driving in the case where the amplitude is lower than the threshold for the reference period.

7. The motor driving circuit according to claim 5, wherein the driving controlling signal generating circuit
controls the driver with the driving controlling signal to perform direct-current excitation driving of the motor and outputs the direct-current excitation start signal to the determining circuit in a case where the driving controlling signal generating circuit receives a command signal that indicates to perform direct-current excitation driving of the motor.

8. The motor driving circuit according to claim 1, further comprising a resistor circuit connected to the driver,
wherein the detecting circuit
detects a voltage value responsive to a voltage drop caused by the driving current flowing from the driver to the resistor circuit and outputs the first voltage signal according to a result of the detection.

9. The motor driving circuit according to claim 1, wherein the motor is a three-phase motor.

10. The motor driving circuit according to claim 9, wherein the driver has:
a first transistor connected to a power supply at a first end thereof and receives a first driving controlling signal output from the driving controlling signal generating circuit at a control terminal thereof;
a second transistor connected to a second end of the first transistor at a first end thereof and receives a second driving controlling signal output from the driving controlling signal generating circuit at a control terminal thereof;
a third transistor connected to the power supply at a first end thereof and receives a third driving controlling signal output from the driving controlling signal generating circuit at a control terminal thereof;
a fourth transistor connected to a second end of the third transistor at a first end thereof and receives a fourth driving controlling signal output from the driving controlling signal generating circuit at a control terminal thereof;
a fifth transistor connected to the power supply at a first end thereof and receives a fifth driving controlling signal output from the driving controlling signal generating circuit at a control terminal thereof; and
a sixth transistor connected to a second end of the fifth transistor at a first end thereof and receives a sixth driving controlling signal output from the driving controlling signal generating circuit at a control terminal thereof,
wherein a first terminal between the first transistor and the second transistor is connected to a coil of a first phase of the motor, a first driving voltage being output at the first terminal,
a second terminal between the third transistor and the fourth transistor is connected to a coil of a second phase of the motor, a second driving voltage being output at the second terminal,
a third terminal between the fifth transistor and the sixth transistor is connected to a coil of a third phase of the motor, a third driving voltage being output at the third terminal,
the resistor circuit has:
a first resistor connected between a second end of the second transistor and a ground;
a second resistor connected between a second end of the fourth transistor and the ground; and
a third resistor connected between a second end of the sixth transistor and the ground, and
the detecting circuit detects a voltage between the second end of the second transistor and the first resistor and outputs the first voltage signal according to a result of the detection.

11. A motor apparatus, comprising:
a motor;
a driver that supplies a driving voltage that drives the motor to the motor; and
a motor driving circuit that performs sensorless driving of the motor by controlling the driver with a driving controlling signal in response to a command signal output from a microcomputer,
the motor driving circuit has:
a driving controlling signal generating circuit that controls the driver with the driving controlling signal;
a detecting circuit that outputs a first voltage signal based on a driving current flowing to the driver in a case where the motor is being driven by direct-current excitation driving;
a calculating circuit that removes a direct-current component from the first voltage signal and outputs a resulting second voltage signal; and
a determining circuit that determines, based on an amplitude of the second voltage signal, whether or not to make the motor transition from the direct-current excitation driving to forced commutation driving and outputs a determination signal according to a result of the determination to the driving controlling signal generating circuit.

12. The motor apparatus according to claim 11, wherein the driving controlling signal generating circuit
controls the driver with the driving controlling signal to perform forced commutation driving of the motor in a case where the determination signal indicates that it is determined to transition to the forced commutation driving.

13. The motor apparatus according to claim 11, wherein the determining circuit
compares the amplitude of the second voltage signal with a threshold and determines to transition from the direct-current excitation driving of the motor to the forced commutation driving in a case where the amplitude is lower than the threshold for a preset reference period.

14. The motor apparatus according to claim 12, wherein the determining circuit
compares the amplitude of the second voltage signal with a threshold and determines to transition from the direct-current excitation driving of the motor to the forced commutation driving in a case where the amplitude is lower than the threshold for a preset reference period.

15. The motor apparatus according to claim 13, wherein the determining circuit
starts the comparison between the amplitude of the second voltage signal and the threshold in response to a direct-current excitation start signal output from the driving controlling signal generating circuit to start the direct-current excitation driving, and
outputs the determination signal that indicates that it is determined to transition to the forced commutation driving in the case where the amplitude is lower than the threshold for the reference period.

16. The motor apparatus according to claim 14, wherein the determining circuit
starts the comparison between the amplitude of the second voltage signal and the threshold in response to a direct-current excitation start signal output from the driving controlling signal generating circuit to start the direct-current excitation driving, and
outputs the determination signal that indicates that it is determined to transition to the forced commutation driving in the case where the amplitude is lower than the threshold for the reference period.

17. The motor apparatus according to claim 15, wherein the driving controlling signal generating circuit
controls the driver with the driving controlling signal to perform direct-current excitation driving of the motor and outputs the direct-current excitation start signal to the determining circuit in a case where the driving controlling signal generating circuit receives a command signal that indicates to perform direct-current excitation driving of the motor.

18. The motor apparatus according to claim 11, further comprising a resistor circuit connected to the driver,
wherein the detecting circuit
detects a voltage value responsive to a voltage drop caused by the driving current flowing from the driver to the resistor circuit and outputs the first voltage signal according to a result of the detection.

19. The motor apparatus according to claim 11, wherein the motor is a three-phase motor.

20. The motor apparatus according to claim 19, wherein the driver has:
a first transistor connected to a power supply at a first end thereof and receives a first driving controlling signal output from the driving controlling signal generating circuit at a control terminal thereof;
a second transistor connected to a second end of the first transistor at a first end thereof and receives a second driving controlling signal output from the driving controlling signal generating circuit at a control terminal thereof;
a third transistor connected to the power supply at a first end thereof and receives a third driving controlling signal output from the driving controlling signal generating circuit at a control terminal thereof;
a fourth transistor connected to a second end of the third transistor at a first end thereof and receives a fourth driving controlling signal output from the driving controlling signal generating circuit at a control terminal thereof;
a fifth transistor connected to the power supply at a first end thereof and receives a fifth driving controlling signal output from the driving controlling signal generating circuit at a control terminal thereof; and
a sixth transistor connected to a second end of the fifth transistor at a first end thereof and receives a sixth driving controlling signal output from the driving controlling signal generating circuit at a control terminal thereof,
wherein a first terminal between the first transistor and the second transistor is connected to a coil of a first phase of the motor, a first driving voltage being output at the first terminal,
a second terminal between the third transistor and the fourth transistor is connected to a coil of a second phase of the motor, a second driving voltage being output at the second terminal,
a third terminal between the fifth transistor and the sixth transistor is connected to a coil of a third phase of the motor, a third driving voltage being output at the third terminal,
the resistor circuit has:
a first resistor connected between a second end of the second transistor and a ground;
a second resistor connected between a second end of the fourth transistor and the ground; and
a third resistor connected between a second end of the sixth transistor and the ground, and
the detecting circuit detects a voltage between the second end of the second transistor and the first resistor and outputs the first voltage signal according to a result of the detection.
